(19) United States
(12) Patent Application Publication
(10) Pub. No.: US 2016/0376202 A1
(43) Pub. Date: Dec. 29, 2016

(54) Apparatus and Methods

(71) Applicant: SMART SEPARATIONS LIMITED, London (GB)

(72) Inventor: Hugo Miguel Magalhaes Macedo, London (GB)

(21) Appl. No.: 14/903,161

(22) PCT Filed: Jul. 10, 2014
(86) PCT No.: PCT/GB2014/052106

§ 371 Date: Jan. 6, 2016

(30) Foreign Application Priority Data
Jul. 10, 2013 (GB) 1312390.6

(51) Int. Cl. C04B 38/00; C04B 35/46; B01D 61/14; C04B 35/565; C04B 35/634; C04B 35/638; C04B 35/10; C04B 35/48

(52) U.S. Cl. CPC C04B 38/0051; C04B 35/10; C04B 35/46; C04B 35/48; C04B 35/565; C04B 35/634; C04B 35/638; B01D 61/147; C04B 2235/3217; C04B 2235/3232; C04B 2235/3244; C04B 2235/3826; C04B 2235/612; C04B 2235/945; B01D 2325/02; B01D 2325/04

(57) ABSTRACT

We describe a method of manufacturing a ceramic filter having a controlled filter channel opening size, the method comprising: fabricating a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise ceramic material; and sintering said ceramic precursor element to fuse said ceramic material and remove said polymer material; the method further comprising removing a controlled thickness portion of said first surface to open said flared pores to said controlled filter channel opening size.

### FIELD OF THE INVENTION

This invention relates to methods of manufacturing ceramic filters, to filters manufactured by such methods, and to medical apparatus incorporating such filters.

### BACKGROUND TO THE INVENTION

It is known to fabricate filters from thin plastic films using track-etch techniques, bombarding the films with charged particles and subsequently performing a chemical etch. Another technique uses a laser beam to drill pores in a polymeric membrane. A third approach is to employ lithography. However these filters tend to be weak, expensive and unsuitable for many applications.

In principle ceramic materials should be advantageous for microfiltration, but there is no easy technique for producing on-demand pore sizes.

Background prior art can be found in:

U.S. Pat. No. 6,479,099B
U.S. Pat. No. 5,340,779A
EP1020276A
US2004091709A
US2002074282A
WO03072233A
US2007142208A
US2011100910A
US2008022644A
US2007119135A
U.S. Pat. No. 4,746,341A
US2006192326A
KR100445768B

Further background prior art can be found in: “Preparation, Characterization And Permeation Property Of Al2o3, Al2o3-Sio2 And Al2o3-Kaolin Hollow Fiber Membranes”, Han Et Al. Journal Of Membrane Science, Volume 372, Issues 1-2, 15 Apr. 2011, Pages 154-164; and in “Optimization Of Hybrid Hyperbranched Polymer/Ceramic Filters For The Efficient Absorption Of Polyaromatic Hydrocarbons From Water”, Tsetsekou A. Et Al. Journal Of Membrane Science, Volume 311, Issues 1-2, 20 Mar. 2008, Pages 128-135.

### SUMMARY OF THE INVENTION

According to the present invention there is therefore provided a method of manufacturing a ceramic filter having a controlled filter channel opening size, the method comprising: fabricating a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise ceramic material; and sintering said ceramic precursor element to fuse said ceramic material and remove said polymer material; the method further comprising removing a controlled thickness portion of said first surface to open said flared pores to said controlled filter channel opening size.

In embodiments the ceramic precursor element is fabricated by forming a dope into a desired shape for the element, the dope comprising the ceramic material, the polymer, and a solvent for the polymer. The formed shape is then treated in a bath of liquid in which the solvent (but not the polymer) is miscible. For example a polar solvent in combination with an aqueous (water) bath may be employed. Broadly speaking during treatment the solvent is replaced by the liquid (water) in the bath in a manner which forms convection cells leaving a substantially regular arrangement of generally conical pores extending between the surfaces of the precursor element. In principle inorganic materials other than ceramic materials may be employed. The apexes of the flared pores do not quite reach the first surface, although in embodiments they may just intersect this surface leaving very small apertures, for example less than 0.1 μm, if the element comprises a very thin membrane. During firing the polymer material is burnt off leaving flared apertures in the sintered ceramic. Then by removing a controlled thickness layer of material from the first surface the flared pores can be opened to a desired extent.

The precursor element may, in embodiments, comprise a thin sheet or membrane of material, or a tube of material. A portion of the first surface may be removed by depositing a solvent onto this surface, preferably of the same class (polar or non-polar) as that in the ceramic precursor and leaving the solvent to dissolve a thin layer of the first surface, optionally aided by shaking. For example solvent may be poured onto the top of a membrane or a tubal fibre may be dipped into a solvent. The solvent is left for a period of, for example, of order 1 minute to of order 24 hours, the dissolution process being halted by placing the ceramic precursor into an oven for sintering.

Additionally or alternatively a portion of the first surface of the ceramic precursor element may be removed physically, for example by means of a controlled height cutter such as a knife blade on an adjustable lead screw—such an arrangement can typically control the thickness of material removed to better than 1 μm. This process may be performed dry or with lubricant, before sintering. After sintering material may be removed by abrasion, for example using a controllable height spinning abrading disc such as a diamond polisher, or by employing a sandpaper-like abrasion process employing ceramic particles of a similar material to the ceramic material in the filter—for example micron scale or sub-micron scale aluminium oxide particles, diamond, and/or silicon oxide. In another approach, fibre optic lapping film may be used to abrade the surface; this may employ a variety of materials, such as silicon oxide, diamond, aluminium oxide, titanium dioxide, and so forth.

The invention also provides a ceramic filter having a structure comprising first and second surfaces and an arrangement of flared passageways extending between and connecting with said first and second surfaces.

In embodiments the conical pores in the ceramic precursor are all substantially the same size and have substantially the same included angle at the apex. Thus by removing material from the first surface the size of the pores can be accurately controlled-although in practice embodiments of the technique we describe tend to place an upper limit on the maximum dimension (diameter) of the opening of a pore—which is a useful property for a filter.

Embodiments of the filter structure have flared passageways, which is useful in reducing the risk of obstruction/blocking. Typical filter pore diameters are in the range 0.1-20 μm, although larger pores may be fabricated (limited by the size of the pore at the second surface, which depends on the thickness of the element). Thus in embodiments of a filter fabricated by the process the flared passages are generally circular and more than 90% have a diameter (at one or both ends) of greater than 0.1 μm, 0.2 μm, 0.5 μm or 1 μm. In embodiments the opening of the passages may have a diameter (at one or both ends) of less than 100 μm, 50 μm, 30 μm, 20 μm, 10 μm, 5 μm or 2 μm. This is useful as such pore sizes are difficult to produce reliably by other techniques.

One advantageous application of a filter manufactured by the above described technique is in separating components of blood, in particular separating red blood cells from other blood components. For example platelets may have a diameter of less than 1 μm, red blood cells may have a dimension of around 7 μm, and white blood cells, and other cells in the blood such as stem cells, may have a dimension in the range of 10-20 μm. Thus by selecting a pore size of less than 5 μm, 4 μm, 3 μm or 2 μm (a red blood cell may squeeze through a hole as small as 1-3 μm) a leukoreduction filter may be fabricated. Conventional blood filtration apparatus can lose of order 5-10% of red blood cells in the filtration process, but blood filtration apparatus incorporating ceramic filter of the type we have described can be substantially more efficient. In addition the quality of the residue is enhanced and the residue may be recovered to extract material such as stem cells or white blood cells, for example for research.

Although embodiments of the techniques we have described are particularly useful for fabricating filters with a controlled pore dimension, they may more generally be employed for fabricating a ceramic filter element without necessarily controlling the pore dimension and, potentially, employing other inorganic materials than ceramic materials.

Thus in a further aspect the invention provides a method of manufacturing an inorganic filter, the method comprising: fabricating a precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise inorganic material; and sintering said precursor element to fuse said inorganic material and remove said polymer material; the method further comprising removing a portion of said first surface to open said flared pores.

The previously described techniques may all be employed in embodiments of this aspect of the invention. In particular a portion of the first surface may be removed physically and/or chemically prior to sintering and/or after sintering, in particular using the previously described techniques. Filters manufactured in this manner may likewise be used in, for example, blood filtering apparatus or cell separation in general.

In typical embodiments of the fabrication process a thin (eg 2-3 μm) skin is left over the second surface. Where present this can be removed, before or after sintering, by processes as described above to fabricate the filter structure. Alternatively it may be left in place to enable the fabrication of a set of flared wells of controllable aperture.

Thus in a further aspect of the invention there is provided a ceramic plate having a structure comprising first and second surfaces and an arrangement of flared passageways extending between and connecting with one of said first and second surfaces to define a set of flared wells. There is further provided a method of manufacturing such a plate.

In principle the filter structure may have applications other than filtering. For example one or both surfaces may be patterned, for example by selective abrasion, and the patterned structure may be used to as a mask for visible or non-visible light. Such selective abrasion may be performed, for example, by a CNC router. A mask of this type may be used, for example, to display a logo or potentially, with a smaller scale pattern, as a mask to photolithography.

Thus the invention further provides a method of manufacturing a ceramic plate having a controlled channel opening size, more particularly a method of manufacturing a mask, the method comprising: fabricating a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise ceramic material; and sintering said ceramic precursor element to fuse said ceramic material and remove said polymer material; the method further comprising removing a controlled thickness portion of said first surface to open said flared pores to said controlled channel opening size.

The invention also provides a plate/mask structure comprising first and second surfaces and an arrangement of flared passageways extending between and connecting with said first and second surfaces, optionally wherein the arrangement of flared passageways of the plate/mask structure is patterned.

In embodiments of the above described manufacturing methods/filters/plates/structures a surface of the filter may be treated to modify a physical, chemical or biological characteristic of the surface, in particular to provide the filter with a surface coating. For example the surface may be plasma treated, say to render the surface hydrophilic or hydrophobic, and/or the surface may be treated with a molecular material to functionalise the surface. In embodiments a surface of the filter is coated to modify the filtration characteristics, in particular to more effectively select or filter out one or more targets.

The invention also provides a method of filtering particles from a fluid (liquid or gas) using a filter as described above/as manufactured by an above-described method.

### BRIEF DESCRIPTION OF THE DRAWINGS

These and other aspects of the invention will now be further described, by way of example only, with reference to the accompanying figures in which:

FIGS. 1a and 1b show, schematically, a principle of pore size control in a method of manufacturing a ceramic filter according to an embodiment of the invention, and schematic views from the top and bottom of an embodiment of a filter manufactured in this way;

FIGS. 2a and 2b show, respectively fabrication of a fibre precursor element and fabrication of a membrane/wafer precursor element;

FIG. 3 shows, schematically, a vertical cross-section through a water bath-treated membrane precursor element;

FIG. 4 illustrates an example of a controlled height cutter which may be employed for removing a layer from the ceramic precursor element;

FIGS. 5a and 5b illustrate a circular ceramic element, and use of a diamond polisher to abrade a sintered ceramic element;

FIG. 6 illustrates, schematically, blood filtering using a ceramic filter according to an embodiment of the invention;

FIG. 7 shows a range of particle separations of embodiments of membrane filters according to the invention (labelled “microfiltration”), alongside other separation principles for different particle sizes;

FIG. 8 shows an image of a top view of a ceramic filter according to an embodiment of the invention under the microscope (magnification of 100×), and a schematic illustration of a diagonal cut across the top of the filter that was employed to provide pores with different opening dimensions along the length of the membrane surface shown; and

FIG. 9 shows a set of images of functional filters manufactured using a method according to an embodiment of the invention, showing: 9a) a cross-sectional view of a membrane (microscope magnification of 100×); 9b) a top view of a membrane after abrasion of the top surface (microscope magnification of 100×); 9c) a top view of the membrane in FIG. 9b after further abrasion of the top surface (microscope magnification of 100×); 9d) a bottom view of a membrane after abrasion of the bottom surface (microscope magnification of 100×); and 9e) a perspective view of the top of a membrane filter as prepared according to the described method (disc diameter 50 mm).

### DETAILED DESCRIPTION OF PREFERRED EMBODIMENTS

Techniques to produce ceramic materials out of sol-gel casting include making a dope solution, composed of a binder (or dispersant), a solvent wherein said binder is soluble and a ceramic material in crystal form (such as, but not limited to, aluminium oxide, zirconia oxide, and the like). These produce highly organised internal pores. We employ modified such structures for the microfiltration of particles in the micrometer range (0.1 μm-100 μm). Advantages of the filters include robustness due to the stable materials used, low price, and a simple manufacturing process. Applications include treatment of fermentation broths and solvent extracts, processing of alginates, pyrogen and bacteria removal, production of antibiotics and others, for example in situations where high temperatures and/or high pressures and/or acidic or basic conditions are present. We will also describe their use for blood filtration. In particular we will describe techniques for producing on-demand pore sizes on the membrane, to allow it to be tailored for a particular microfiltration application.

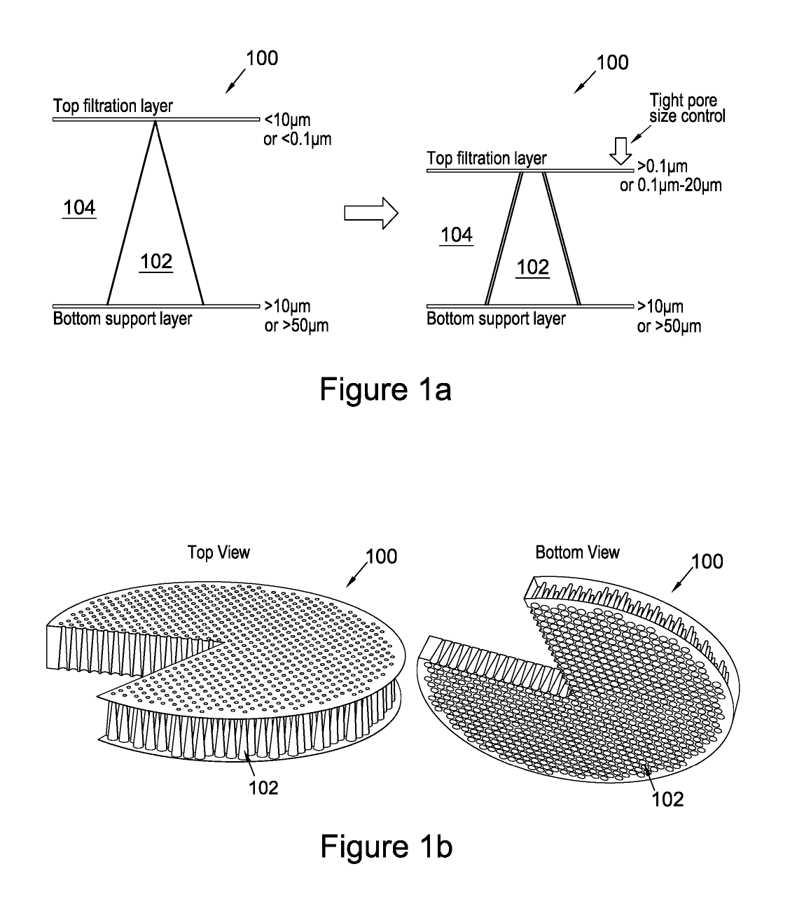

The ceramic membrane filters 100 that are obtained by embodiments of the techniques we describe are composed of conical shaped pores 102, as illustrated in FIG. 1, that cross through these membranes 104, top to bottom. With this pore geometry the production of membranes 104 of different pore size distributions can be achieved by producing membranes 104 in large batches (which reduces the manufacturing costs), afterwards tailoring the pores 102 for an intended application—i.e. with variable pore sizes. Such a method allows a reduction in the time and cost requirements to develop a tailor-made filter—by changing e.g. the dope solution ratios, the type of non-solvent, the temperature of the sintering process, the drying time of the membrane film 104, the thickness of the filter 100 and so forth, one can change the pore angle/packing density and other filter parameters.

Thus we describe the manufacture of tailor-made pore sizes in ceramic filters 100, allowing their use in a wide range of applications in the field of microfiltration, particularly in filtration of cells.

Initially a dope solution is prepared with a mixture of a solvent, a ceramic-based material, and a polymer.

The solvent may be, but is not limited to: dimethylformamide, dimethylsulfoxide, dimethylformamide, dimethylacetamide, N-methyl-2-pyrrolidone, hexamethylphosphoramide, dioxane, others derived therefrom or other organic solvents available that can dissolve the polymer.

The ceramic-based material may be, but is not limited to: aluminum oxide, titanium oxide, zirconium oxide, silicon carbide, glassy materials, or any other similar materials, optionally surface-treated with cross-linking agents.

The polymer material may be, but is not limited to: polyamide, poly (caprolactone), polyurethane, poly (L-lactic-co-glycolic acid), polyacrylonitrile, polyimide, poly (methylmethacrylate), poly (D, L-lactate), polystyrene, polyether ether ketone, polyethersulphone, polyvinylidene fluoride, polysulfone, polyethersulfone or any other similar material, preferably surface-treated with cross-linking agents. The polymer acts as a water-insoluble binder in the dope; it should be burnt away at sintering temperatures (600-1500° C.).

Optionally a dispersing agent/surfactant can be added to the mixture. The dispersing agent may be, but is not limited to: alkylbenzenesulfonates, lignin sulfonates, fatty alcoholethoxylates, alkylphenol ethoxylates, PEG 30 dipolyhydroxystearate, sodium stearate, 4-(5-Dodecyl) benzenesulfonate, sodium dodecyl sulphate, cetrimonium bromide, fluorosurfactants, siloxane surfactants, alkyl ethers, block copolymers of polyethylene glycol and polypropylene glycol, others derived therein, and/or any other amphiphilic compound.

In an example embodiment the solvent is dimethylsulfoxide, the ceramic is aluminum oxide, the polymer is polyethersulphone, and the dispersing agent is PEG 30 dipolyhydroxystearate.

The dope solution is then cast to a smooth surface, using a casting knife or other method to control the thickness of the casted coating. The shape of the cast dope solution may hereby be adjusted according to the desired shape of the ceramic precursor element to be fabricated. The cast dope solution is then immediately transferred into a water bath and left standing there for a period longer than 5 minutes, typically overnight, to set. During this process the solvent is gradually replaced by the water, surface tension effects at the surface, and convection, resulting in the development of a substantially regular pattern of conical polymer-containing regions. The polymer and/or the polymer/ceramic material mixture are not substantially dissolved in the water bath. The film is then removed from water and allowed to dry for a period longer than 5 minutes, e.g. 24 hours.

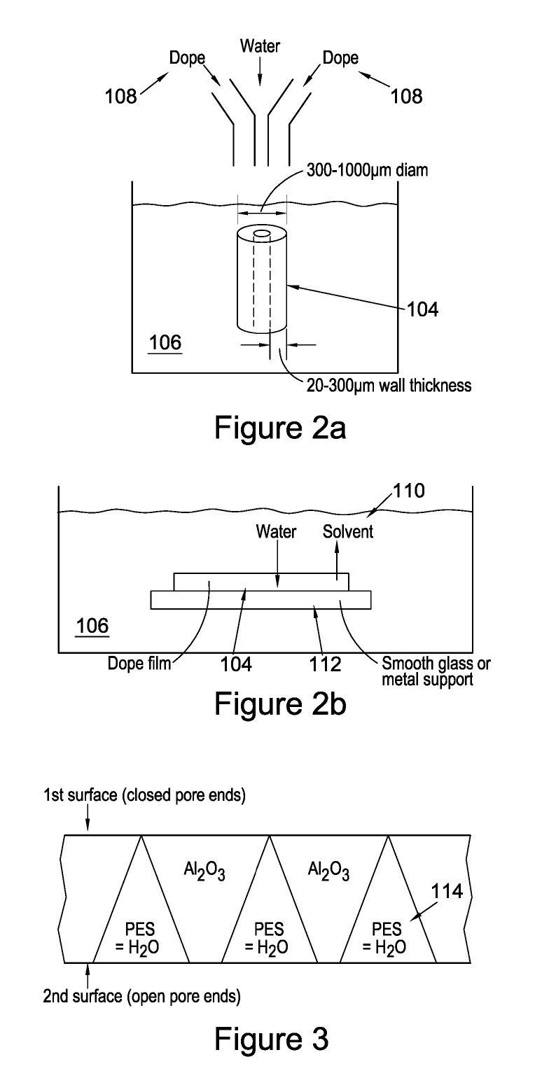

FIG. 2a illustrates a tubular precursor membrane 104 in a water bath 106; FIG. 2b illustrates a process of forming a tubular precursor element 104. FIG. 3 illustrates a cross-section of the membrane 104 of FIGS. 2a and b after treatment in the water bath—the PES is burnt away during sintering. Typically the membrane may be of order 50 μm thickness.

In more detail, as shown in FIG. 2a, the dope solution 108 which comprises the ceramic-based material, the polymer and the solvent is placed into a water bath 106. In this example, the precursor element 104 has a tubular shape with a diameter of 300-1000 μm and a wall thickness of 20-30 μm. It will be appreciated that the precursor element 104 may be of any shape, which may be determined by the particular use of the ceramic membrane filter 100.

FIG. 2b shows an example in which the precursor element 104 has a tabular shape. The precursor element 104 may be prepared on a smooth metal layer 112 which allows for a smooth precursor element 104 to be formed thereon. As illustrated in FIG. 2b, the metal layer 112 may be replaced with a smooth glass or other suitable support which allows for preparing a smooth precursor element 104.

It can be seen that when the precursor element 104 is placed into the water bath 106, water penetrates into the precursor element 104 and replaces the solvent 110 which is released into the water bath 106. As outlined above, the precursor element 104 may be placed in the water bath 106 for a period longer than 5 minutes.

FIG. 3 shows a cross-sectional view of the precursor element 104 prepared as illustrated in FIG. 2b. It can be seen that in the area where pores 102 are to be fabricated, a mixture 114 of water and the polymer is formed.

In order to remove the water/polymer mixture 114 from the precursor element 104, the film is first removed from the water bath 106 and then left to dry for a pre-determined amount of time. Afterwards, the polymer may be burnt away by sintering at a pre-determined temperature, in this example between 600-1500° C.

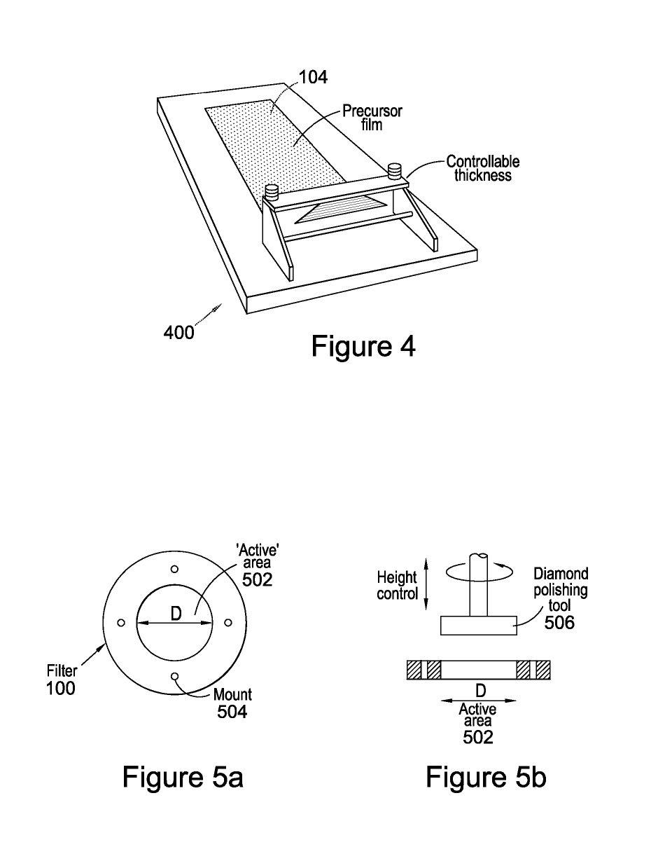

After forming the precursor element 104, a tool 400, such as a casting knife or other similar device (FIG. 4), is used to remove the top layer of the membrane film 104, by scrapping the surface and removing a thickness between 0 μm and the final thickness of the film 104. The thickness of the layer of the film 104 to be scraped off is controllable by the tool 400 used for scrapping. This procedure can also be accomplished by pouring a solvent (from the list described above) on top of the membrane film and allow it to stand on top of the membrane film for a period, typically longer than 1 second, or shaking it to accelerate the process, scrapping the surface of the membrane to clean using the same method described above and immediately proceeding to sintering of the film.

The film is then cut into the desired shape of the filter, for example a circle, as shown in FIG. 5a. This may be done using a circular knife. The membrane is then sintered, for example at a temperature above 600 degrees Celsius for a period of the order of two hours, followed by at least 1 hour (for example 3-4 hours) at 1200-1600 degrees Celsius. Afterwards, the membrane filter is optionally further processed by abrading the surface of the membrane, to render its pores larger according to the time, pressure and abrading material used. FIG. 5b shows polishing of the central, active region 502 of a filter 100, held in place by mounts 504 at the edge. In this example, a diamond polishing tool 506 is placed on the top of the central, active region 502 of the filter 100. The diamond polishing tool 506 has the shape of a circular disc, and is rotated around its own axis as illustrated to abrade the surface of the filter 100 in the active region 502. The skilled person will appreciate that the pressure exerted onto the active region 502 via tool 506, the roughness and abrasiveness of the diamond polishing tool 506, the spinning speed, and other parameters may determine the abrading rate. It will be appreciated that the diamond polisher may be replaced with another suitable material for abrading the active region 502. The diamond polishing tool 506 may be controllable in a vertical direction as shown in FIG. 5b in order to define the amount of material on the active region 502 to be abraded.

Thus, two main options are available to control the pore sizes: process 1) after casting of the membrane film 104 and before sintering of the film 104; and process 2) after sintering of the film 104, having attained the ceramic filter 100. Both processes can be undertaken either alone or combined, in order to give a filter 100 a desired pore size specification.

Process 1, before sintering, may be achieved by removing a top layer of the cast membrane 104, removing a thickness of between 0 μm and the final thickness of the dried film 104, before or after drying. This may be performed by placing a solvent on top of the membrane 104, allowing it to rest there for a period, typically longer than 1 second, or shaking it to accelerate the process, then scrapping the surface of the membrane 104 to clean using a tool 400, such as a casting knife or other similar and then evaporating the solvent by immediately transferring the film 104 into a hot oven. The longer the exposure of the membrane 104 to the solvent, the larger the pores 102 produced. Another method which can be used in process 1 is to use a tool 400, such as a casting knife or other similar, to remove the top layer of the membrane (the thicker the gap of the tool 400 used, the smaller the pore sizes in the resulting filter 100), or by using a soft tool to gently scrap the surface of the film 104 (depending on the strength and/or the time during which this is done will produce membranes 104 with controllable pore sizes).

Process 2, which may be used in addition to process 1 or on its own, is performed after sintering and can achieve better tuneable control of the pore sizes. This is achieved by abrading the surface of the membrane 104, to render its pores 102 larger depending on the time, pressure and abrading material used (e.g. “sandpaper” or a diamond tool).

Using this method, the pore size at the surface of the membrane 104 can be tightly controlled, depending on the process(es) used, the perpendicular force exerted over the membrane film 104, and the material(s) used. This facilitates a one-step universal manufacture process of a base comprising a ceramic membrane disc, which can then be tailored for different applications, following process(es) 1 and/or 2.

As it can be seen from FIG. 1, in a pore 102 with conical geometry seen transversally and in 2 dimensions, by changing the amount of abrasion at the smaller-pore size end it is possible to create pores 102 with a controlled, variable size.

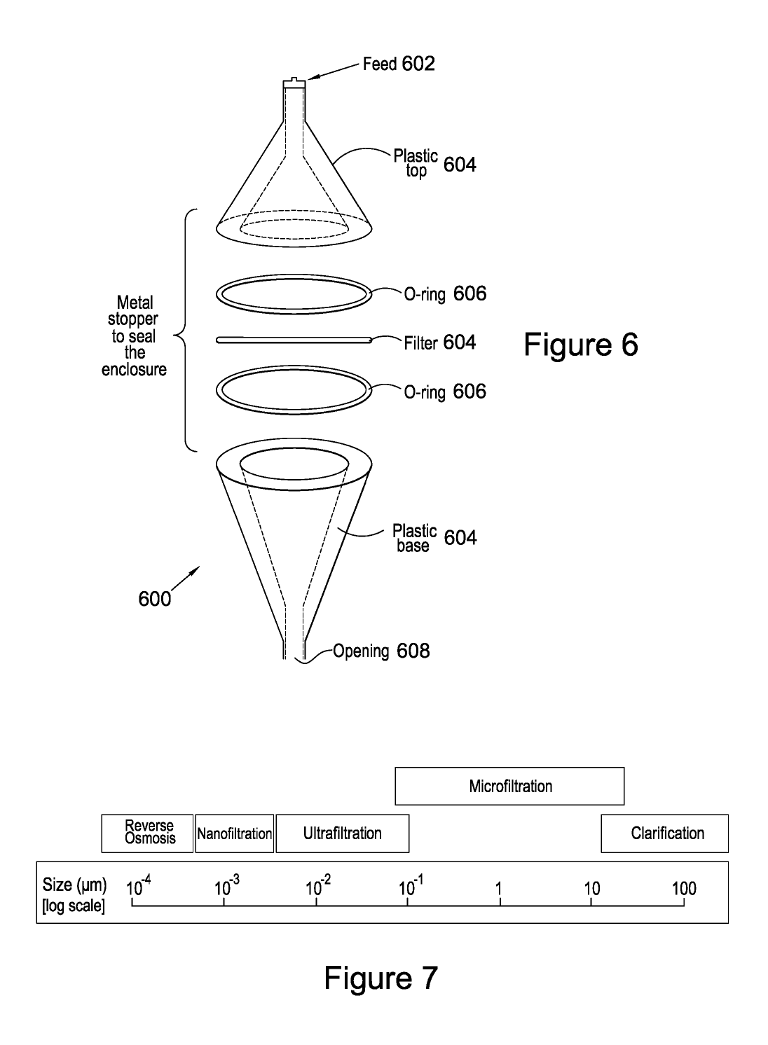

Filters 100 fabricated by these techniques are useful for membrane filtration for the industrial separation of blood cells to eliminate leukocytes (to reduce the risk of infection). Membrane filtration is simple and inexpensive and it is easy to maintain sterility during the process. An example schematic illustration of such blood filtering apparatus 600 is shown in FIG. 6.

As shown in FIG. 6, the filter 100 is sandwiched between a plastic top 604 and a plastic base 610. Two seals (O-rings) 606 are provided, between the filter 100 and the plastic top 604 and plastic base 610, respectively. The plastic top 604 comprises a feed 602 through which the material to be filtered by filter 100 may be inserted into apparatus 600. The plastic base 610 comprises an opening 608 through which the filtered material may then be collected. The assembly may be held together by a metal strap.

FIG. 7 shows a range of particle separations of embodiments of membrane filters. It can be seen that a range of filters comprising pores with a broad range of sizes (in this example ˜0.1 μm to a few tens of μm) may be fabricated using techniques described herein. It will be understood that the size of the pores may be determined by the size of the specific material(s) to be filtered.

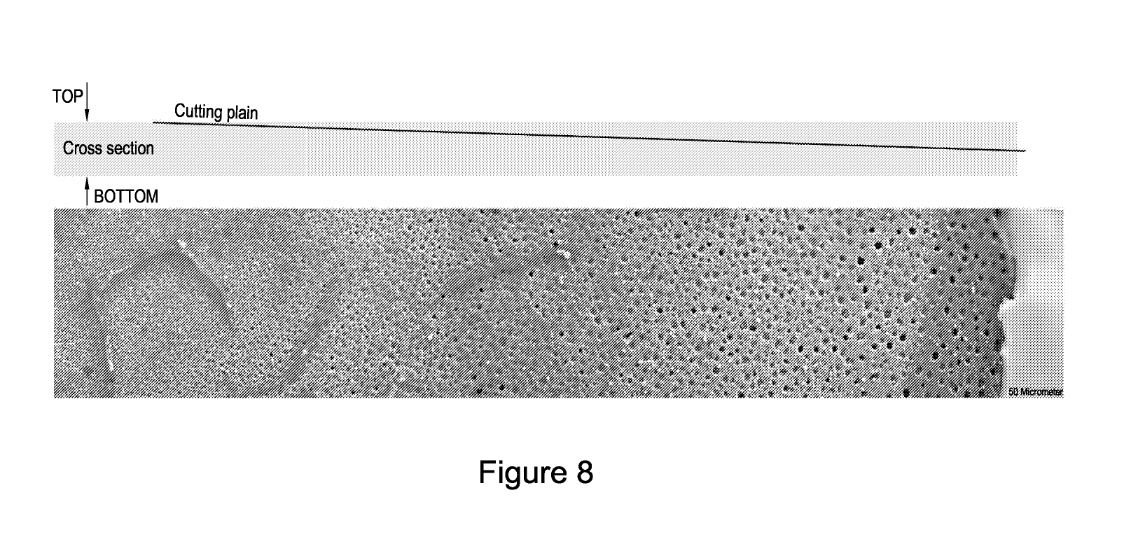

FIG. 8 shows a top-view of a ceramic filter prepared using techniques as described herein. As illustrated in the schematic cross-sectional view, the filter is cut such that the cut is deeper towards the right-hand side of the filter. As can be seen, the depth of the cut determines the opening size of the pores.

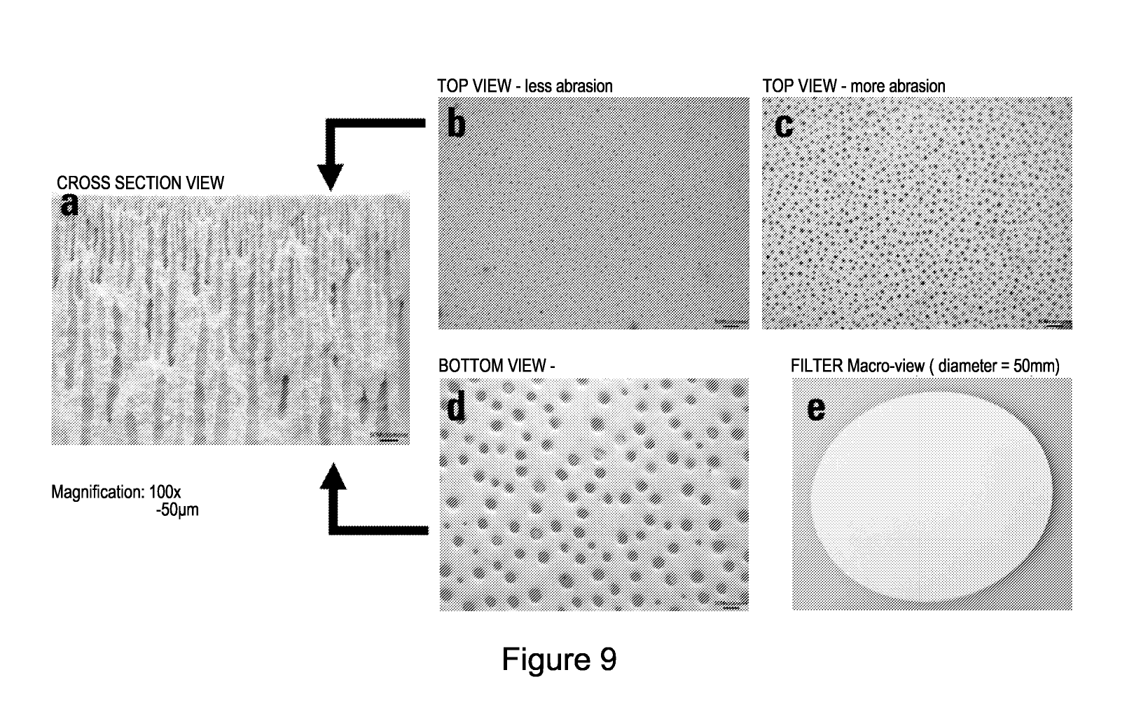

FIG. 9a shows a cross-sectional view of the filter. It can be seen that the diameter of the pores increases towards the bottom of the membrane filter. FIGS. 9b and c show top-views of the filter illustrated in FIG. 9a. As already illustrated in FIG. 8, the diameter of the opening of the pores at the top surface of the filter is determined by the depth of abrasion of the top surface of the membrane. FIG. 9d shows a bottom-view of the filter. The opening of the pores is larger in diameter as described above.

FIG. 9e shows a perspective view of the top of a membrane filter with a diameter of, in this example, 50 mm. As described above, the shape of the membrane filter may be adjusted according to the specific implementation of the filter.

More generally ceramic filters are useful in harsh environmental conditions (chemical/thermal/pH), and also when high pressures are required during the separation process or afterwards (for example for regenerating a membrane).

Such harsh conditions are not generally present when filtering human cells but the high strength of ceramic filters confers an important advantage in this application by facilitating the creation of a more densely packed pore structure. This in turn helps to maintain the shape and viability of filtered cells by reducing the stresses arising from the passage of the cells through the filter.

Further Applications

Further applications of the technology described herein are now described: The microfilter is a platform technology with applications in many different industries.

Microfiltration membranes can separate suspended solids (such as metal hydroxides, micron-sized particles, as well as macro-materials), gases (particularly in the form of bubbles), immiscible liquids (such as in emulsions), etc. Typical materials removed can include cells, starch, bacteria, molds, yeast, emulsified oils, dust, hair particles, gas bubbles and the like. We here give a non-exhaustive list of further applications but, broadly speaking, the technology is useful in any application that requires the separation of particles with sizes larger than 0.1 μm. The technology may also serve as a starting point for further products by, for example, coating the surface of the inorganic material with a substance or group of substances with particular properties to render further advantages to the use of the filter.

Thus some example applications include: cell separation (stem cells and the like) for research and development purposes; blood leukoreduction; blood cell fractionation; blood salvage; biotech/biopharma/pharmaceuticals applications; food and beverage applications; dairy applications; applications involving the generation of potable water; applications involving the industrial processing of water; wastewater processing applications; chemical and petrochemical applications; applications in the field of semiconductors/semiconductor processing; applications in the field of electronics and photonics; air filtration applications; applications of the structures providing reactive wells; removal of gas bubbles; other physics and more general applications.

Each of these may employ the rejection, from a fluid flow, of particles that fall within or above a size range of the technology described. In general terms, the microfilters may be used as “pre-filters” for a number of more sensitive separations: for example air purification filters can easily become clogged with dust and other particles; the use of the technology we describe allows a coarse separation of this larger debris, prolonging the life of more sensitive filters downstream. More detailed descriptions of some of the above applications now follow.

Cell Separation

The technology herein disclosed provides a method of performing cell separation based on size differences. An example is in separating stem cells and other progenitor cells from fully functional cells—such as nucleated reticulocytes from enucleated red blood cells.

Blood Leukoreduction

By leukodepletion or leukoreduction of collected whole blood, is meant removing white blood cells from whole blood or from constituents such as plasma, red blood cells or platelets. The technology allows tuning the size of the filter micropores to exclude the large white blood cells present in blood from all the other smaller blood cells/particles (plasma, platelets and red blood cells).

Blood Cell Fractionation

By using different membrane pore sizes and/or different filter configurations, the system allows for the fractionation of blood into its main components: plasma, platelets, red blood cells and nucleated cells.

Blood Salvage

Surgical blood salvage is a hospital procedure where automated systems are used to collect blood lost during or after surgery, clean it, and make it available for reinfusion to the patient. The technology herein disclosed can be used as a “cell-saver” device that before infusing the blood back into the patient filters it towards removing any emboli and/or any large foreign debris that contaminated this blood—particularly, fibres from the surgery equipment, dust or any other large particle.

Biotech/Biopharma/Pharmaceuticals

The technology has applications where relatively large particles need to be processed, for example in the production/separation of antibodies or other active substances from cells. The technology can also be used in bioprocessing, aiding cell harvesting, protein concentration, clarification and production of pharmaceutical makeup water. Other applications include fine dining and cooking; minimal processed food (reducing requirements for water/chlorine). A further application is the decomposition of human faeces for research: these are composed of organic food, bacteria, proteins and small metabolites (e.g. sugar)—for example, in order of decreasing size, size 1 could separate food debris; size 2 removes bacteria; size 3 removes proteins; and finally size 4 collects small metabolites. Other applications include size sorting for microcapsules; sperm viability for in vitro fertilisation; diagnosis and disease screening in developing countries (e.g., the parasites' eggs could be separated to detect their presence, or the liquid to analyse (water, blood, etc.) could be removed to concentrate the parasite and thus increase the chance of detection using normal methods); lypossomes (structures that contain molecules inside) of variable and controllable size; antigen-based cell sorting with bead-size coding; explore mechanisms of cell-cell signalling; 3D cell culture; microcapsules formation (inhibiting shrinking of microcapsules during production).

Food & Beverage

This includes applications in the following fields: dairy, alcoholic beverages (wine and beer), sugar and sweeteners, juice, protein recovery and wastewater reuse. Microfiltration membranes can be used for the clarification of juice, wine, beer, vinegar, sugar syrups; cold sterilization of wine and beer; for whey filtration; for milk fractionation and extended shelf life milk. The technology can also be used in producing new milk-based liquid and dry ingredients, and low-carbohydrate dairy beverages with high protein content. These membrane microfilters also present a high resistance in extreme food processing conditions, such as fouling, heat and chemicals, and repeated exposure to hot water and caustics, which are useful characteristics.

Dairy

Currently, the industry of skimmed milk uses microfiltration membranes for its clarification and sterilisation. The two main applications of MF in the dairy industry use filters with 1.4 or 0.1 μm mean pore diameter membranes, which are currently mainly commercialised for drinking and cheese milks. Our microfilters are potentially more robust and enable the production of larger pore size membranes, which can lead to higher flow rates.

Potable Water

The technology can be used for the production of drinking water, particularly through the direct removal of turbidity, parasites, bacteria, cysts, etc. Moreover, it can also be used as a pretreatment to reverse osmosis and nanofiltration membrane separations. The potential to produce different pore sizes in narrow increments facilitates the development on a case-by-case scenario of filtration membranes with optimal flux/separation performance. Other applications within this scope include the pretreatment to desalination plants using reverse osmosis: the technology allows the removal of bacteria, colloidal particles, plankton and algae from the raw feed, which can increase the life span of the more expensive reverse osmosis membranes.

Industrial Process Water

Industries that benefit from the advantages of this technology include large-volume water users such as electric power generators, oil and gas producers, and chemical manufacturers. As an example, cooling towers capture close to 3 kg per day in pollen, dust, insects, exhaust, and the like while over time the areas of water collection for recycle see a build-up of biofilm, which slows down and even clogs recovery systems altogether. Pre-treatment of these waters, which do not have to be at a “drinkable quality” can helps reducing the costs of running these industries. Other applications include pre-treatment prior to reverse osmosis and nanofiltration membrane filtrations. The technology can also be used for separation and/or recovery of catalysts, caustics, degreasers, dyes, sizing agents, separation of oil/water emulsions, amongst others.

Wastewater

The technology herein disclosed can remove bacteria, Giardia and other microorganisms from contaminated water, and remove heavy metals for recovery e.g. from industrial processes. Due to their particular strength, the membranes we describe can also be used in the clean-up of radioactive waste, in treating nuclear laundry water and removing uranium from aqueous streams. They can be used for separation and/or recovery of catalysts, caustics, degreasers, dyes, sizing agents, separation of oil/water emulsions, amongst others. The technology can also be used as a pretreatment to other downstream filtration processes by reverse osmosis, nanofiltration or ultrafiltration membrane separations: wastewater free from large particles and contaminants will increase the life span and hence leading to cost reduction of the more expensive reverse osmosis, nano and ultrafiltration membranes.

Chemical & Petrochemical Industries

The disclosed microfiltration membranes can be used as part of the ultrapure water manufacturing methods and for the detoxification of chemical wastewaters, particularly as pretreatment barriers. The filters can be used in the chemical industry for secondary and tertiary catalyst recovery, solvent recovery, chemical clarification, and for the removal of solid and liquid contaminants from feedstreams entering reactor processes. Other uses in these fields include as filters for chemical solution deposition (in thin-film technologies), to remove large particles (such as dust) from petroleum and gas extraction, as well as for other refinery processes downstream.

Electronics/Photonics/Semiconductors

Applications such as in chemical purification and copper slurry filtration are possible using the technology disclosed. The technology disclosed can also be used as a mask for applications such as lithography imprinting. The pores can act as a light-guide, and at the narrow end of the funnel can effectively reduce spot size, thus potentially increasing light guiding accuracy and reducing scatter. Shining a light through the membrane pores arranged according to a predetermined structure, with varying pore sizes, can also be useful for related applications, for example, to create a predetermined shape into an object placed on the other side of the membrane. The technology can also be used for alignment of particle/light trajectories. Still further a large scale embodiments of the structure could be used, for example, as a publicity or display panel, for example by patterning an image into the filters, which can then be used to project light and/or viewed akin to a window. This may also be used for “secret messaging”-the filters may bear an image that is only seen when light is shone through the filter.

Air

The technology can be used in non-liquid media, particularly, in purifying or treating air or other gas. As an example, the technology may be used as a pre-treatment to other air filtration processes (usually for removal of odours or air-borne viruses) by nanofiltration or ultrafiltration membrane separations. Removing air-borne large particles such as dust, hair particles, and the like can increase the life span of the more expensive nano- and ultrafiltration membranes. Many other applications in air filtration are possible.

Reactive Wells

If only one side of the membrane is abraded, the resulting wells can be used in a number of applications, such as for batch chemical reactions.

Physics

Applications are not constrained to filtering physical particles. The technology can be used for optical diffraction grating; surface plasmons; metamaterial waveguides (which use evenly spaced pores); unusual geometry filters; coupled with weighing sensors (to allow e.g. quantifying the amount of substances that pass through); used to test the sphericity of a particle; as a sieve for high-purity powders and nano-powders; x-ray diffraction; in aerodynamics (by building a structure with special aerodynamic features resulting from the pore; the creation of graphene using the pore structures; organic switches for computers in 3D; as a particle size filter for spectroscopy (to filter to <100 μm to inhibit light scattering); as a hard mask to control materials growth (manipulate materials processing); to produce patterned nanomaterials; and so forth.

Removal of Gas Bubbles

Micron-sized gas bubbles, such as air bubbles, can be a nuisance in certain industries. Examples include industries where injection molding is used or molten metal is poured into a mould, to produce car wheel rims, window handles. In general the existence of air bubbles and/or undissolved particles can cause problems in a process for producing a product which employs the manufacturing steps of melting a media and pouring it into a mould followed by solidification (for example by temperature reduction, contact with non-solvents, evaporation, or other techniques). Particularly, existence of air bubbles or undissolved particles may compromise the structure of such products, potentially leading to cracks and breaks. Prior filtration of the media, optionally at elevated temperatures, is possible using the technology herein disclosed to remove air bubbles (which may be micron-sized) or undissolved particles (which may be larger).

Other Applications

The technology herein disclosed can also be used in a many other fields, for example: air testing/car debris filter; oil separation (particularly from the earth debris and other large particles); domestic use (in a vacuum cleaner and the like); in a gas hob to burn gas more efficiently; as an allergen filter, e.g. for asthma; to provide a pollen filters for air conditioning and other similar applications; as a self-cleaning filter for e.g. automotive applications (relying on the ruggedness and non-clogging nature of the ceramic disk); in agriculture, for example for sorting seeds; and so forth.

The technology can also be used as a starting point for post-treatment to adapt the technology to the previously described or other applications. In particular, the surface of the filter may be modified by methods such as plasma treatment, chemical etching or crosslinking, adsorption or any other method of coating. This is particularly useful in order to add to the filter membrane one or more of: functional biomolecules such as amino-acids; antimicrobial compounds such as copper, silver, gold or any other metal or a mixture of these; oxidizers such as boron(III) oxide, silicon (IV) oxide, chromium (III) oxide, manganese (IV) oxide, iron (III) oxide, iron(II, III) oxide, copper(II) oxide, lead(II,IV) oxide, amongst others; and other chemical elements or molecules that may render the membrane filter less or more permeable to a specific or a group of particles or substances (based, for example, on charge, molecular weight, size, mobility, chemical affinity, amongst others, for example, for a targeted cell type or a molecule of interest).

No doubt many other effective alternatives will occur to the skilled person. It will be understood that the invention is not limited to the described embodiments and encompasses modifications apparent to those skilled in the art lying within the spirit and scope of the claims appended hereto.

1. A method of manufacturing a ceramic filter having a controlled filter channel opening size, the method comprising:
fabricating a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise ceramic material; and
sintering said ceramic precursor element to fuse said ceramic material and remove said polymer material;
the method further comprising removing a controlled thickness portion of said first surface to open said flared pores to said controlled filter channel opening size.

2. A method as claimed in claim 1 wherein said removing of said controlled thickness portion comprises depositing a solvent onto said first surface of said ceramic precursor element.

3. A method as claimed in claim 1 wherein said removing of said controlled thickness portion comprises physically removing a controlled thickness from said first surface of said ceramic precursor element.

4. A method as claimed in claim 1, wherein said removing of said controlled thickness portion comprises abrading said first surface of said sintered ceramic precursor element.

5. A method as claimed in claim 1 wherein said fabrication of said ceramic precursor element comprises:
forming a dope comprising said ceramic material, said polymer, and a solvent for said polymer into a shape for said ceramic precursor element; and
treating said formed shape in a bath of a liquid which said solvent is miscible.

6. A method as claimed in claim 5 wherein said shape of said ceramic precursor element is a sheet or tube.

7. A method as claimed in claim 1 further comprising removing a portion of said second surface to open said flared pores.

8. A method as claimed in claim 1 further comprising applying a surface modification treatment to the filter after manufacture to modify a filtration characteristic of the filter.

9. A method of filtering cells using the ceramic filter of claim 1.

10. A ceramic filter manufactured by the method of claim 1.

11. A ceramic filter having a structure comprising first and second surfaces and an arrangement of flared passageways extending between and connecting with said first and second surfaces, wherein openings of said flared passages are generally circular and more than 90% have a diameter greater than 0.1 μm, and wherein more than 90% of said openings of said flared passages have a diameter less than 50 μm.

12. (canceled)

13. A ceramic filter as claimed in claim 11, wherein more than 90% of said openings of said flared passages have a diameter less than 5 μm.

14. A ceramic filter as claimed in claim 11, wherein a surface of said filter has a functionalising surface coating or treatment.

15. Blood filtering apparatus comprising the filter of claim 11.

16. A method of manufacturing an inorganic filter, the method comprising:
fabricating a precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise inorganic material; and
sintering said precursor element to fuse said inorganic material and remove said polymer material;
the method further comprising removing a portion of said first surface to open said flared pores.

17. A ceramic filter manufactured by the method of claim 16.

18. A method of filtering particles from a fluid using a filter as claimed in claim 11.

19. A method of manufacturing a mask, the method comprising:
fabricating a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise ceramic material; and
sintering said ceramic precursor element to fuse said ceramic material and remove said polymer material;
the method further comprising removing a controlled thickness portion of said first surface to open said flared pores to said controlled channel opening size.

20. A method as claimed in claim 19 further comprising patterning pore openings on one or both of said first and second surfaces.

21. A mask manufactured by the method of claim 19, the mask having a structure comprising first and second surfaces and an arrangement of flared passageways extending between and connecting with said first and second surfaces to provide flared, light-transmitting passageways through said mask, wherein said arrangement of flared passageways of the plate/mask structure is patterned to define a light-transmitting pattern for said mask.
